(19) United States
(12) Patent Application Publication
(10) Pub. No.: US 2025/0080820 A1
(43) Pub. Date: Mar. 6, 2025

(54) IMAGING DEVICE

(71) Applicant: SAMSUNG ELECTRO-MECHANICS CO., LTD., Suwon-si (KR)

(72) Inventors: Yong Joo JO, Suwon-si (KR); Tae Yeon LIM, Suwon-si (KR)

(73) Assignee: SAMSUNG ELECTRO-MECHANICS CO., LTD., Suwon-si (KR)

(21) Appl. No.: 18/807,462

(22) Filed: Aug. 16, 2024

(30) Foreign Application Priority Data
Aug. 28, 2023 (KR) 10-2023-0112972

(51) Int. Cl. H04N 23/55; H04N 23/698

(52) U.S. Cl. CPC H04N 23/55; H04N 23/698

(57) ABSTRACT

An imaging device includes a first lens assembly including a plurality of first lens modules and a single first image sensor, and a second lens assembly including a plurality of second lens modules and a single second image sensor, wherein the first lens assembly and the second lens assembly are arranged to be adjacent to each other, wherein a field of view of each first lens module of the plurality of first lens modules is wider than a field of view of each second lens module of the plurality of second lens modules, and wherein f35t/f35w≥2 is satisfied, where f35t is a 35 mm equivalent focal length of the second lens module and f35w is a 35 mm equivalent focal length of the first lens module.

### CROSS-REFERENCE TO RELATED APPLICATIONS

This application claims the benefit under 35 USC 119(a) of Korean Patent Application No. 10-2023-0112972 filed on Aug. 28, 2023, in the Korean Intellectual Property Office, the entire disclosure of which is incorporated herein by reference for all purposes.

### BACKGROUND

### 1. Field

The present disclosure relates to an imaging device.

### 2. Description of the Background

Imaging devices have been used in portable electronic devices, such as smartphones, tablet PCs, and laptops. An imaging device generally includes a plurality of lenses and image sensors.

In order to capture high-resolution images or videos, the number of pixels in image sensors may be increased and the size of image sensors themselves may also be increased. In addition, the number of lenses may be increased.

Since the size of an imaging device mounted on a portable electronic device may be affected by the size of the portable electronic device, it may be desired to design an imaging device having a short total track length, while supporting high resolution.

However, due to limitations in the size of portable electronic devices, there are physical limitations in designing an imaging device having a short total track length, while supporting high resolution.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an imaging device includes a first lens assembly including a plurality of first lens modules and a single first image sensor, and a second lens assembly including a plurality of second lens modules and a single second image sensor, wherein the first lens assembly and the second lens assembly are arranged to be adjacent to each other, wherein a field of view of each first lens module of the plurality of first lens modules is wider than a field of view of each second lens module of the plurality of second lens modules, and wherein f35t/f35w≥2 is satisfied. Here, f35t is a 35 mm equivalent focal length of the second lens module and f35w is a 35 mm equivalent focal length of the first lens module.

TTL_w/IMG HT_Fw<0.85 may be satisfied, where TTL_w is a distance on an optical axis from an object-side surface of a front lens of the first lens module to an imaging plane of the single first image sensor, and IMG HT_Fw is half of a diagonal length of the imaging plane of the single first image sensor.

Fno_w>fw/IMG HT_Aw may be satisfied, where Fno_w is an F-number of the first lens module and IMG HT_Aw is half a diagonal length of a region of the imaging plane of the single first image sensor divided to correspond to the plurality of first lens modules.

TTL_t/IMG HT_Ft<1.45 may be satisfied, where TTL_t is a distance on the optical axis from an object-side surface of a front lens of the second lens module to an imaging plane of the single second image sensor and IMG HT_Ft is half of a diagonal length of the imaging plane of the single second image sensor.

Fno_t>(ft/IMG HT_At)×0.9 may be satisfied, where Fno_t is an F-number of the second lens module and IMG HT_At is half of a diagonal length of a region of the imaging plane of the single second image sensor divided to correspond to the plurality of second lens modules.

The first lens assembly may include a plurality of wide-angle lens arrays arranged in order from an object side to an image side, the plurality of wide-angle lens arrays may respectively include a plurality of lenses, and the first lens module may include a plurality of lenses arranged in different lens arrays and sharing a single optical axis.

The second lens assembly may include a plurality of tele-lens arrays arranged in order from an object side to an image side, the plurality of tele-lens arrays may respectively include a plurality of lenses, and the second lens module may include a plurality of lenses arranged in different lens arrays and sharing a single optical axis.

The first lens module may include a first lens, a second lens, a third lens, a fourth lens, and a fifth lens arranged along an optical axis from an object side toward an image side, the first lens may have positive refractive power, and the second lens may have negative refractive power.

A difference in Abbe numbers between the first lens and the second lens may be greater than 30 and less than 50.

The second lens may have a refractive index greater than 1.67 and an Abbe number less than 21.

The third lens may have positive refractive power, and the fourth lens may have negative refractive power.

The second lens module may include a first lens, a second lens, a third lens, a fourth lens, and a fifth lens arranged along an optical axis from an object side toward an image side, the first lens may have positive refractive power, and the second lens may have negative refractive power.

A difference in Abbe numbers between the first lens and the second lens may be greater than 30 and less than 50, and a difference in Abbe numbers between the second lens and the third lens may be greater than 10 and less than 20.

The second lens may have a refractive index greater than 1.64 and an Abbe number less than 24.

The fourth lens may have positive refractive power, and the fifth lens may have negative refractive power.

The plurality of first lens modules may all have substantially the same configuration as each other.

The plurality of second lens modules may all have substantially the same configuration as each other.

In another general aspect, an imaging device includes a first lens assembly comprising a plurality of first lens modules having substantially the same configuration as each other and a single first image sensor, and a second lens assembly disposed adjacent to the first lens assembly, and comprising a plurality of second lens modules having substantially the same configuration as each other and a single second image sensor, wherein a field of view of each first lens module of the plurality of first lens modules is wider than a field of view of each second lens module of the plurality of second lens modules, and wherein TTL_w/IMG HT_Fw<0.85 is satisfied, where TTL_w is a distance on an optical axis from an object-side surface of a front lens of the first lens module to an imaging plane of the single first image sensor, and IMG HT_Fw is half of a diagonal length of the imaging plane of the single first image sensor.

f35t/f35w≥2 may be satisfied, where f35t is a 35 mm equivalent focal length of the second lens module, and f35w is a 35 mm equivalent focal length of the first lens module.

Optical axes of the plurality of first lens modules may be substantially parallel to each other, and optical axes of the plurality of second lens modules may be substantially parallel to each other.

Other features and aspects will be apparent from the following detailed description, the drawings, and the claims.

### BRIEF DESCRIPTION OF DRAWINGS

FIG. 1 is a diagram illustrating a schematic structure of an imaging device according to an example embodiment of the present disclosure.

FIG. 2 is a plan view of an imaging device according to an example embodiment of the present disclosure.

FIG. 3 is a diagram illustrating a schematic structure of an imaging device according to another example embodiment of the present disclosure.

FIG. 4 is a schematic exploded view of an imaging device according to another example embodiment of the present disclosure.

FIG. 5 is a schematic plan view of a first image sensor and a second image sensor.

FIG. 6 is a reference diagram illustrating a method of generating an image with an imaging device according to an example embodiment of the present disclosure.

FIG. 7 is a configuration diagram of a first lens module of a first lens assembly.

FIG. 8 is a diagram illustrating aberration characteristics of the first lens module illustrated in FIG. 7.

FIG. 9 is a configuration diagram of a second lens module of a second lens assembly.

FIG. 10 is a diagram illustrating aberration characteristics of the lens module illustrated in FIG. 9.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure may provide a slim imaging device capable of capturing high-resolution images and videos.

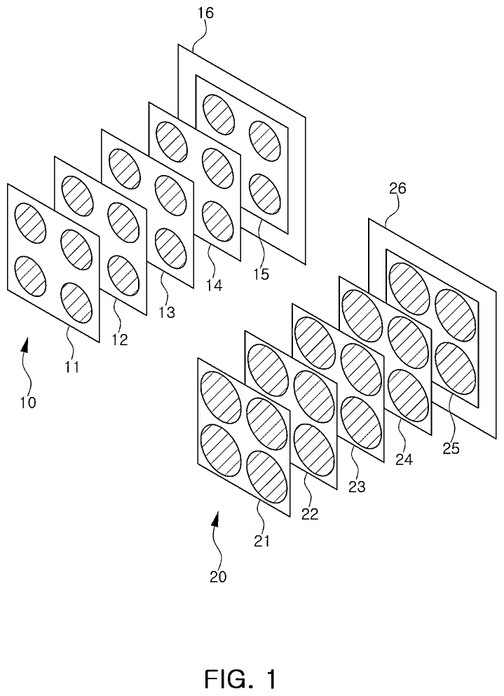

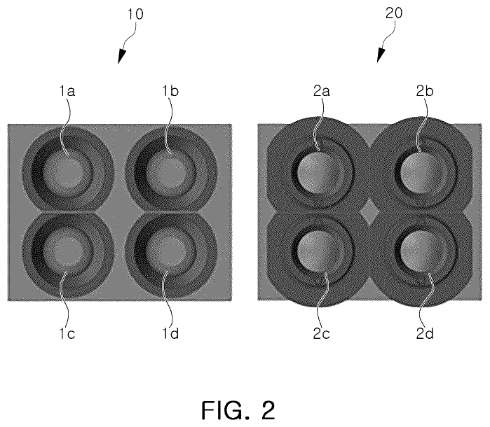

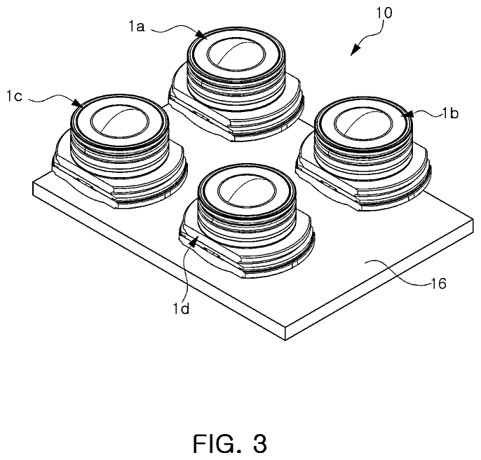

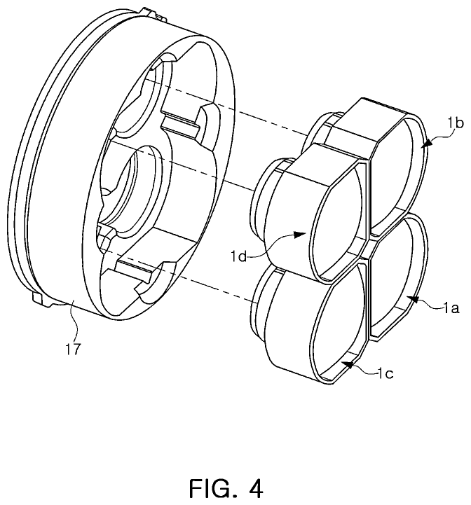

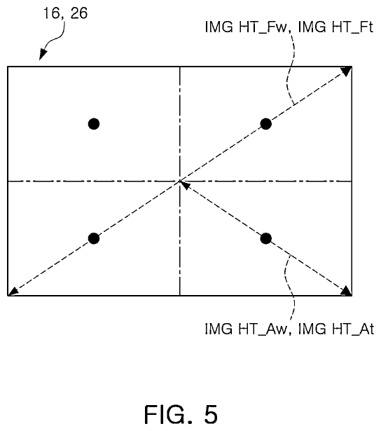

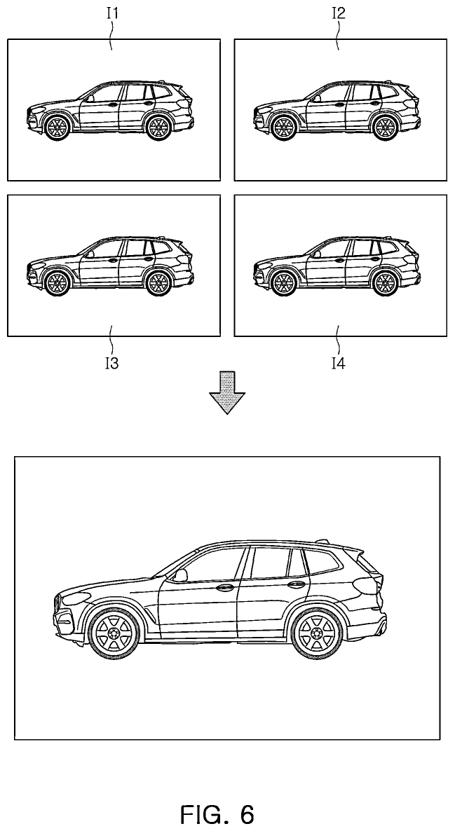

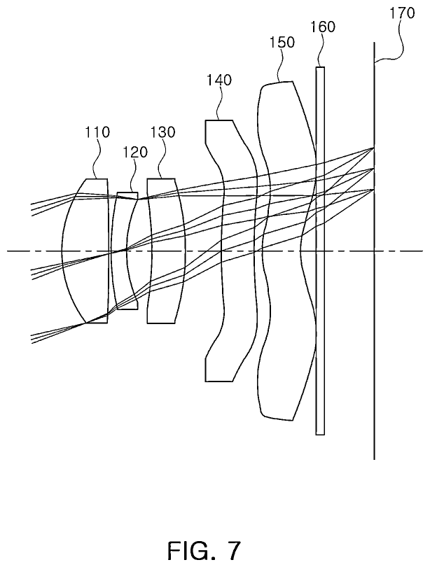

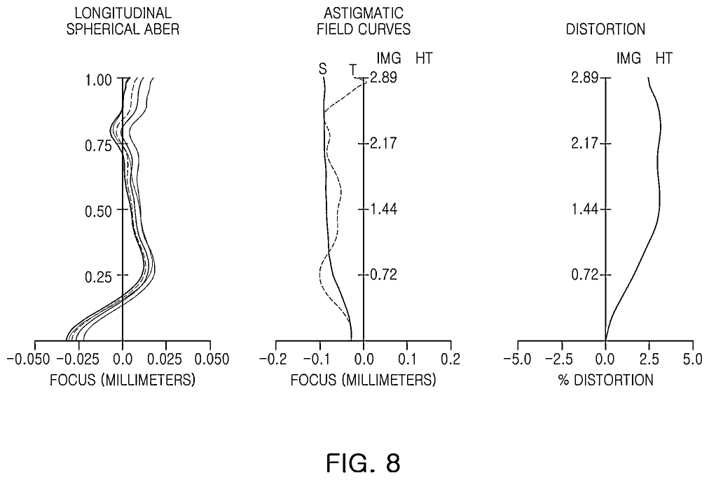

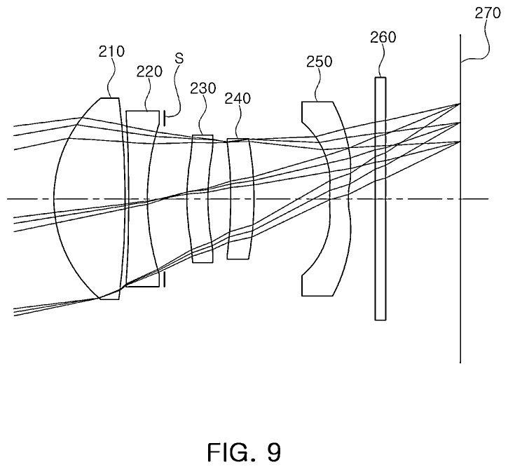

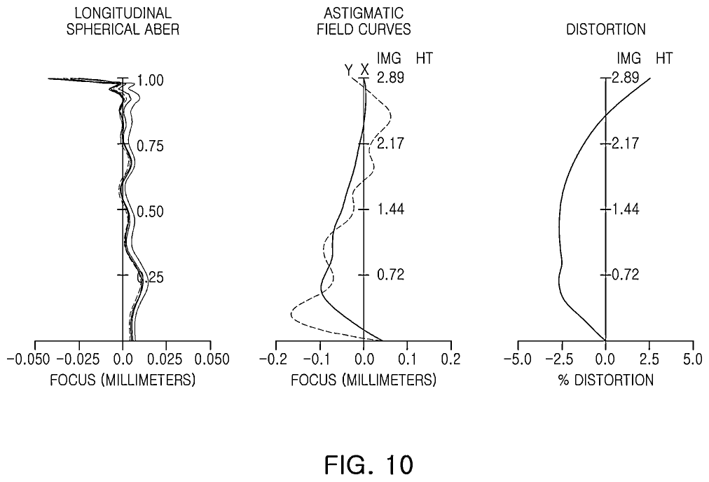

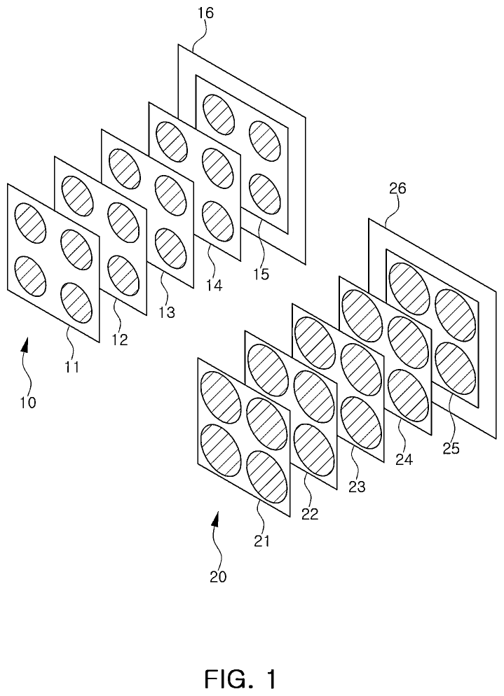

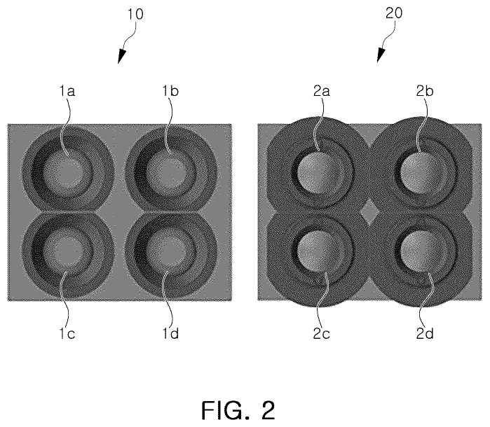

FIG. 1 is a diagram illustrating a schematic structure of an imaging device according to an example embodiment of the present disclosure, and FIG. 2 is a plan view of an imaging device according to an example embodiment of the present disclosure.

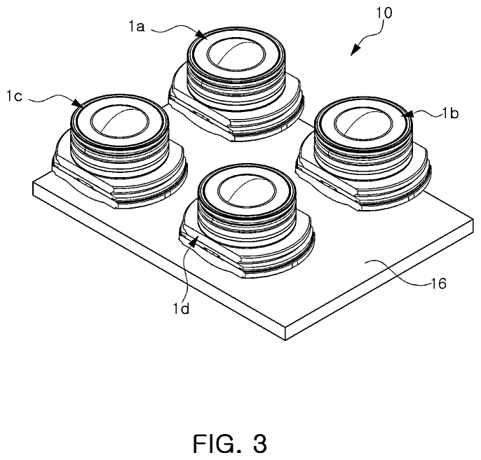

FIG. 3 is a diagram illustrating a schematic structure of an imaging device according to another example embodiment of the present disclosure, and FIG. 4 is a schematic exploded view of an imaging device according to another example embodiment of the present disclosure.

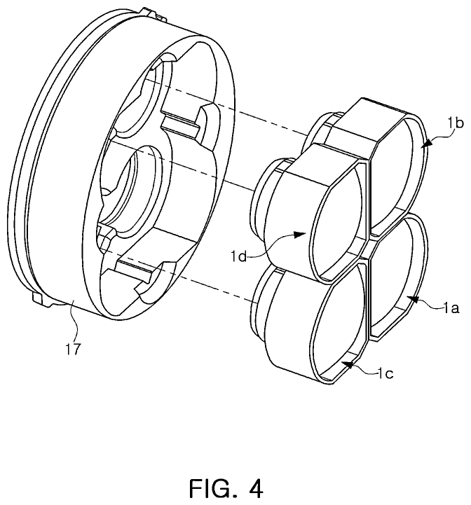

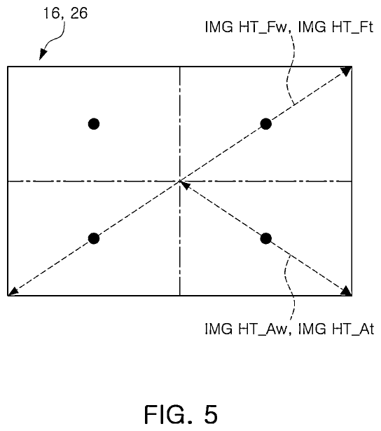

FIG. 5 is a schematic plan view of a first image sensor and a second image sensor.

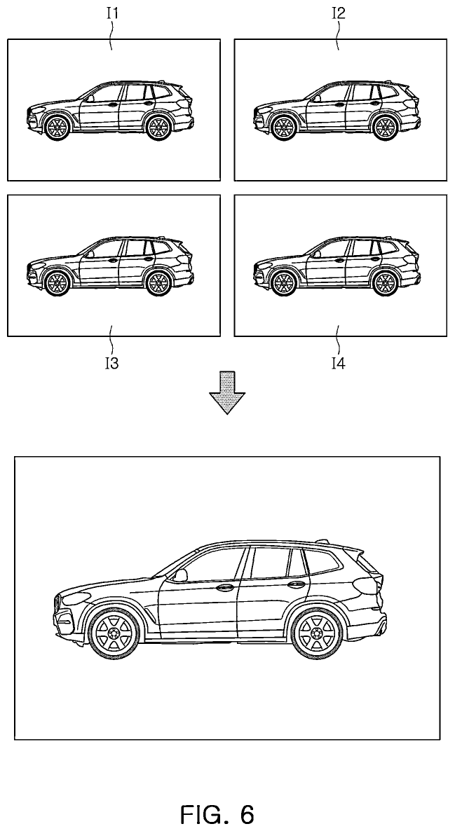

FIG. 6 is a reference diagram illustrating a method of generating an image with an imaging device according to an example embodiment of the present disclosure.

An imaging device according to an example embodiment of the present disclosure may be mounted on a portable electronic device, such as a mobile communication terminal, a smartphone, and a tablet PC.

Referring to FIGS. 1 and 2, an imaging device according to an example embodiment of the present disclosure includes a plurality of lens assemblies.

In an example embodiment, the imaging device includes a first lens assembly 10 and a second lens assembly 20 disposed to be adjacent to each other. Hereinafter, for convenience of description, a plurality of lens assemblies are described as including the first lens assembly 10 and the second lens assembly 20, but the number of lens assemblies may vary as needed.

The first lens assembly 10 includes a plurality of first lens modules having the same configuration, and the second lens assembly 20 includes a plurality of second lens modules having the same configuration.

The field of view of each lens module included in the first lens assembly 10 may be wider than the field of view of each lens module included in the second lens assembly 20.

For example, each lens module included in the first lens assembly 10 may be a wide-angle lens module, and each lens module included in the second lens assembly 20 may be a tele-lens module.

When imaging a subject with the first lens assembly 10, each lens module of the first lens assembly 10 images the same subject, and captured images may be synthesized to generate a single completed image with higher resolution than those of individual images.

In addition, in the case of imaging a subject with the second lens assembly 20, each lens module of the second lens assembly 20 may image the same subject, and captured images may be synthesized to generate a single completed image with higher resolution than those of individual images.

In the case of the wide-angle lens assembly and the tele-lens assembly of the related art, there are physical limitations in designing them to have high resolution and a short total track length.

Therefore, in the imaging device according to an example embodiment of the present disclosure, a plurality of lens assemblies include a plurality of lens modules, respectively, and images captured by the respective lens modules may be synthesized to generate a single image with high resolution, so that the imaging device may have high resolution and a short total track length.

In addition, since the field of view of each lens module included in the first lens assembly 10 is wider than the field of view of each lens module included in the second lens assembly 20, the imaging device may implement a zoom function within a predetermined magnification range.

In an example embodiment, the imaging device may satisfy Conditional Expression 1 below.

f35t/f35w≥2 [Conditional Expression 1]

In Conditional Expression 1, f35t is a 35 mm equivalent focal length of a second lens module included in the second lens assembly 20, and f35w is a 35 mm equivalent focal length of a first lens module included in the first lens assembly 10.

### 1. First Lens Assembly

Referring to FIG. 1, the first lens assembly 10 includes a plurality of wide-angle lens arrays 11 to 15 and a first image sensor 16 arranged in order from an object side toward an image side.

The plurality of wide-angle lens arrays 11 to 15 may be arranged in different layers. The plurality of wide-angle lens arrays 11 to 15 respectively include a plurality of lenses.

For example, one lens array includes a plurality of lenses arranged in the same layer.

In one lens array, a plurality of lenses may be arranged in an n×n matrix structure or an n×m matrix structure, where n and m are each different natural numbers of 2 or more.

The first lens assembly 10 includes a plurality of optical axes. For example, when a plurality of lenses are arranged in a 2×2 matrix structure in each lens array, the first lens assembly 10 includes four optical axes. A plurality of optical axes may be arranged parallel to each other. A plurality of lenses sharing a single optical axis may constitute one lens module.

A plurality of lenses sharing a single optical axis may be lenses arranged in different lens arrays.

When a plurality of lenses are arranged in a 2×2 matrix structure in each lens array, the first lens assembly includes four first lens modules 1a to 1d.

In each of the first lens modules 1a to 1d, a ratio (TTL_w/(2×IMG HT_Fw)) of a distance on the optical axis from an object-side surface of a lens disposed to be closest to an object side to a first image sensor (TTL_w) to a diagonal length of an imaging plane (an effective imaging region) (2×IMG HT_Fw) may be less than 0.4.

The plurality of first lens modules 1a to 1d may be arranged to be adjacent to each other.

The first lens assembly 10 includes the plurality of first lens modules 1a to 1d and the first image sensor 16.

Here, the first image sensor 16 is provided as a single sensor. That is, the first lens assembly 10 does not include a plurality of image sensors respectively corresponding to the plurality of first lens modules 1a to 1d, but includes the single first image sensor 16.

The plurality of first lens modules 1a to 1d may respectively image a subject by dividing the effective imaging region of the single first image sensor 16.

For example, referring to FIG. 6, the imaging device according to an example embodiment of the present disclosure may synthesize low-resolution images 11 to 14 captured by the plurality of first lens modules 1a to 1d to generate a single high-resolution image.

That is, each of the first lens modules may image the same subject and synthesize the captured images to generate a single completed image with higher resolution than those of individual images.

In FIGS. 1 and 2, for convenience of description, an example embodiment in which a plurality of lenses are arranged in a 2×2 matrix structure in each lens array of the first lens assembly 10 (i.e., four first lens modules are arranged) is illustrated.

The first lens assembly 10 may include five lens arrays arranged in order from the object side to the image side. For example, the first lens assembly 10 may include a first wide-angle lens array 11, a second wide-angle lens array 12, a third wide-angle lens array 13, a fourth wide-angle lens array 14, and a fifth wide-angle lens array 15.

Accordingly, one lens module may include five lenses.

Meanwhile, referring to FIGS. 3 and 4, unlike the example embodiment of FIG. 1, a plurality of lenses are not disposed in each of a plurality of lens arrays, but a plurality of first lens modules 1a to 1d which are manufactured separately may be arranged to be adjacent to each other on one first image sensor 16.

Although only the first lens assembly 10 is illustrated in FIGS. 3 and 4, the second lens assembly 20 may also be configured to have a shape similar to that of the first lens assembly 10.

Meanwhile, referring to FIG. 4, the first lens assembly 10 may further include a single lens holder 17 accommodating a plurality of first lens modules. In addition, each of the plurality of first lens modules may include a lens barrel in which a plurality of lenses are disposed.

In an example embodiment, the first lens assembly 10 may satisfy at least one of Conditional Expressions 2 and 3 below.

TTL_w/IMG HT_Fw<0.85 [Conditional Expression 2]

Fno_w>fw/IMG HT_Aw [Conditional Expression 3]

In Conditional Expression 2, TTL_w is the distance on the optical axis from the object-side surface of a front lens (the lens disposed to be closest to the object side) of a first lens module to the imaging plane of the single first image sensor 16, and IMG HT_Fw is half of a diagonal length of the imaging plane of the single first image sensor 16.

In Conditional Expression 3, Fno_w is F-number of a first lens module, and IMG HT_Aw is half of a diagonal length of a region of the imaging plane of the single first image sensor 16 divided to correspond to the plurality of first lens modules. In the case of a 2×2 matrix structure, IMG HT_Aw may be half of IMG HT_Fw.

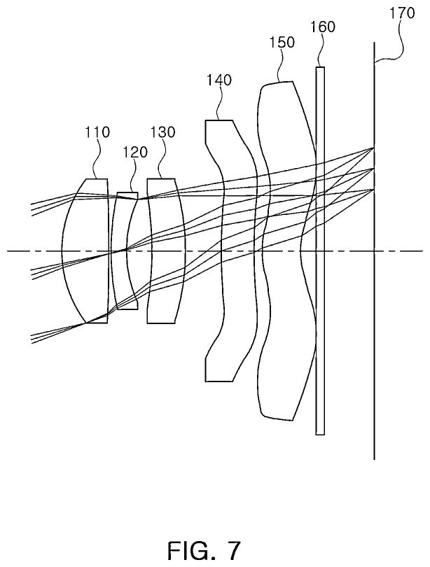

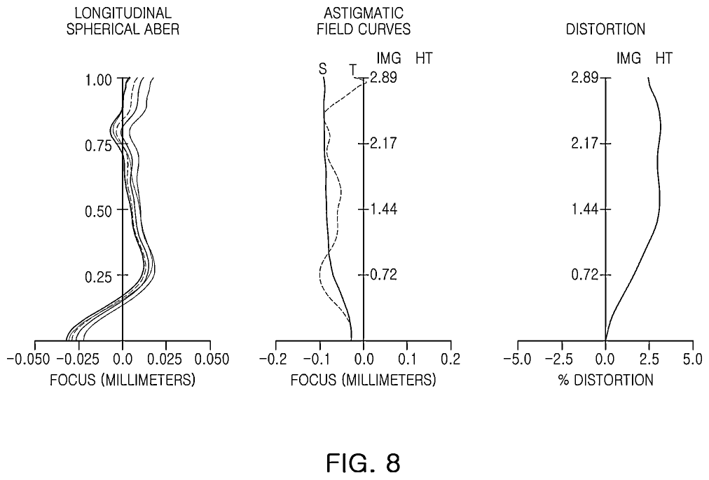

FIG. 7 is a configuration diagram of the first lens module of the first lens assembly, and FIG. 8 is a diagram illustrating aberration characteristics of the first lens module illustrated in FIG. 7.

The first lens module described with reference to FIGS. 7 and 8 may be any one of a plurality of first lens modules of the first lens assembly 10. In addition, the plurality of first lens modules may all have the same configuration.

In this specification, the object-side surface of each lens refers to a surface close to the object side, and the image-side surface refers to a surface close to the image side. In addition, the values for the radius of curvature, thickness, distance, and focal length of the lens are all in mm, and the unit of field of view (FOV) is degree.

In addition, in the description of the shape of each lens, a shape in which one surface is convex means that a paraxial region of the corresponding surface is convex, and a shape in which one surface is concave means that the paraxial region of the corresponding surface is concave. Therefore, the fact that one surface of a lens is convex means that it is convex in the paraxial region.

Meanwhile, the paraxial region refers to a very narrow region near and including the optical axis.

The imaging plane may refer to a virtual plane on which a focus is formed by the first lens module. Alternatively, the imaging plane may refer to a surface of the first image sensor receiving light.

In an example embodiment, the first lens module includes five lenses.

For example, referring to FIG. 7, the first lens module includes a first lens 110, a second lens 120, a third lens 130, a fourth lens 140, and a fifth lens 150 arranged along the optical axis from the object side toward the image side. The first lens 110 to the fifth lens 150 are arranged to be spaced apart from each other by a preset distance along the optical axis.

The first lens 110 to the fifth lens 150 may be lenses arranged in different lens arrays.

The first lens module may further include an infrared cutoff filter 160 (hereinafter referred to as a ‘filter’) to block infrared rays. The filter 160 is disposed between the fifth lens 150 and an imaging plane 170.

In addition, the first lens module may further include an aperture for controlling the amount of light.

The aperture may be disposed between the second lens 120 and the third lens 130.

The first lens 110 to the fifth lens 150 may be formed of plastic.

In addition, the first lens 110 to the fifth lens 150 may each be formed of a plastic material having different optical properties (refractive index, Abbe number, etc.) from lenses disposed to be adjacent to each other.

In an example embodiment, a difference in Abbe numbers between the first lens 110 and the second lens 120 may exceed 30. Also, a difference in Abbe numbers between the second lens 120 and the third lens 130 may exceed 30.

In an example embodiment, the second lens 120 may be formed of a plastic material having high refractive index and low dispersion values. For example, the refractive index of the second lens 120 may be greater than 1.67, and the Abbe number thereof may be less than 21.

In an example embodiment, the fourth lens 140 may be formed of a plastic material having high refractive index and low dispersion values. For example, the refractive index of the fourth lens 140 may be greater than 1.67, and the Abbe number thereof may be less than 21.

In an example embodiment, the lens module may meet a condition of 30<|v1−v2|<50, where v1 is the Abbe number of the first lens 110, and v2 is the Abbe number of the second lens 120.

In an example embodiment, the lens module may meet a condition of 30<|v2−v3|<50, where v2 is the Abbe number of the second lens 120, and v3 is the Abbe number of the third lens 130.

The plurality of lenses constituting the first lens module may have an aspherical surface. For example, each of the plurality of lenses may have at least one aspherical surface.

The first lens module according to an example embodiment of the present disclosure may form a focus on the imaging plane 170. The imaging plane 170 may refer to a plane on which a focus is formed by the first lens module. As an example, the imaging plane 170 may refer to one surface of the first image sensor that receives light.

The lens characteristics (a radius of curvature, a thickness of the lens or a distance between lenses, a refractive index, the Abbe number, a focal length) of each lens are listed in Table 1.

TABLE 1

| Surface | | Radius of | Thickness | Refractive | Abbe |
|---|---|---|---|---|---|
| No. | Remark | curvature | or distance | index | number |
| S1 | First lens | 1.545 | 0.661 | 1.551 | 55.99 |
| S2 | | 242.804 | 0.030 | | |
| S3 | Second lens | 3.319 | 0.219 | 1.684 | 20.38 |
| S4 | | 1.737 | 0.217 | | |
| S5 | Aperture | Infinity | 0.133 | | |
| S6 | Third lens | −11.891 | 0.462 | 1.551 | 55.99 |
| S7 | | −5.956 | 0.512 | | |
| S8 | Fourth lens | 24.898 | 0.453 | 1.684 | 20.38 |
| S9 | | 8.209 | 0.109 | | |
| S10 | Fifth lens | 1.230 | 0.537 | 1.542 | 55.74 |
| S11 | | 1.125 | 0.216 | | |
| S12 | Filter | Infinity | 0.110 | 1.522 | 64.20 |
| S13 | | Infinity | 0.664 | | |
| S14 | Imaging plane | Infinity | | | |

In an example embodiment, a total focal length fw of the first lens module is 3.337 mm (35 mm equivalent focal length is 25 mm), Fno_w is 1.9, and IMG HT_Fw is 6.016 mm.

In an example embodiment, the first lens 110 has positive refractive power, the object-side surface of the first lens 110 is convex, and the image-side surface of the first lens 110 is concave.

The second lens 120 has negative refractive power, the object-side surface of the second lens 120 is convex, and the image-side surface of the second lens 120 is concave.

The third lens 130 has positive refractive power, the object-side surface of the third lens 130 is concave, and the image-side surface of the third lens 130 is convex.

The fourth lens 140 has negative refractive power, the object-side surface of the fourth lens 140 is convex, and the image-side surface of the fourth lens 140 is concave.

In addition, the fourth lens 140 has at least one inflection point formed on at least one of the object-side surface and the image side surface. For example, the object-side surface of the fourth lens 140 may be convex in the paraxial region and concave in portions other than the paraxial region.

The fifth lens 150 has positive refractive power, the object-side surface of the fifth lens 150 is convex, and the image-side surface of the fifth lens 150 is concave.

In addition, at least one inflection point is formed on at least one of the object-side surface and the image-side surface of the fifth lens 150. For example, the object-side surface of the fifth lens 150 may be convex in the paraxial region and concave in portions other than the paraxial region.

The inflection point refers to a point at which the surface of the lens changes from being concave to being convex or from being convex to being concave.

Meanwhile, both the object-side surface and the image-side surface of the first lens 110 to the fifth lens 150 are aspherical surfaces.

In addition, the first lens module configured in this manner may have the aberration characteristics illustrated in FIG. 8.

### 2. Second Lens Assembly

The second lens assembly 20 includes a plurality of tele-lens arrays 21 to 25 and a second image sensor 26 arranged in order from the object side toward the image side.

A plurality of tele-lens arrays 21 to 25 may be arranged in different layers. The plurality of tele-lens arrays 21 to 25 respectively include a plurality of lenses.

For example, one lens array includes a plurality of lenses arranged in the same layer.

In one lens array, a plurality of lenses may be arranged in an n×n matrix structure or an n×m matrix structure, where n and m are each different natural numbers of 2 or greater.

The second lens assembly 20 includes a plurality of optical axes. For example, when a plurality of lenses are arranged in a 2×2 matrix structure in each lens array, the second lens assembly 20 includes four optical axes. A plurality of optical axes may be arranged parallel to each other.

A plurality of lenses sharing a single optical axis may constitute one lens module.

A plurality of lenses sharing a single optical axis may be lenses arranged in different lens arrays.

When a plurality of lenses are arranged in a 2×2 matrix structure in each lens array, the second lens assembly includes four second lens modules 2a to 2d.

In each of the second lens modules 2a to 2d, a ratio (TTL_t/(2×IMG HT_Ft)) of a distance on the optical axis from an object-side surface of a lens disposed to be closest to an object side to a second image sensor (TTL_t) to a diagonal length of an imaging plane (an effective imaging region) (2×IMG HT_Ft) may be less than 0.7.

The plurality of second lens modules 2a to 2d may be arranged to be adjacent to each other.

The second lens assembly 20 includes the plurality of second lens modules 2a to 2d and the second image sensor 26.

Here, the second image sensor 26 is provided as a single sensor. That is, the second lens assembly 20 does not include a plurality of image sensors respectively corresponding to the plurality of second lens modules 2a to 2d, but includes the single second image sensor 26.

The plurality of second lens modules 2a to 2d may respectively image a subject by dividing the effective imaging region of the single second image sensor 26.

For example, referring to FIG. 6, the imaging device according to an example embodiment of the present disclosure may synthesize low-resolution images 11 to 14 captured by the plurality of second lens modules 2a to 2d to generate a single high-resolution image.

That is, each of the second lens modules may image the same subject and synthesize the captured images to generate a single completed image with higher resolution than those of individual images.

In FIGS. 1 and 2, for convenience of description, an example embodiment in which a plurality of lenses are arranged in a 2×2 matrix structure in each lens array of the second lens assembly 20 (i.e., four second lens modules are arranged) is illustrated.

The second lens assembly 20 may include five lens arrays arranged in order from the object side to the image side. For example, the second lens assembly 20 may include a first tele-lens array 21, a second tele-lens array 22, a third tele-lens array 23, a fourth tele-lens array 24, and a fifth tele-lens array 25.

Accordingly, one lens module may include five lenses.

In an example embodiment, the second lens assembly 20 may satisfy at least one of Conditional Expressions 4 and 5 below.

TTL_t/IMG HT_Ft<1.45 [Conditional Expression 4]

Fno_t>(ft/IMG HT_At)×0.9 [Conditional Expression 5]

In Conditional Expression 4, TTL_t is the distance on the optical axis from the object-side surface of a front lens (the lens disposed to be closest to the object side) of a second lens module to the imaging plane of the single second image sensor 26, and IMG HT_Ft is half of a diagonal length of the imaging plane of the single second image sensor 26.

In Conditional Expression 5, Fno_t is F-number of a second lens module, and IMG HT_At is half of a diagonal length of a region of the imaging plane of the single second image sensor 26 divided to correspond to the plurality of second lens modules. In the case of a 2×2 matrix structure, IMG HT_At may be half of IMG HT_Ft.

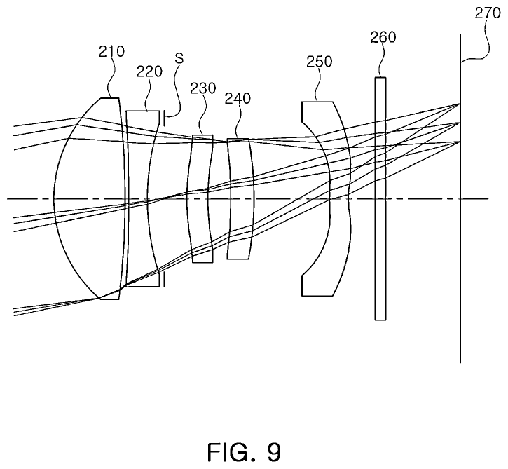

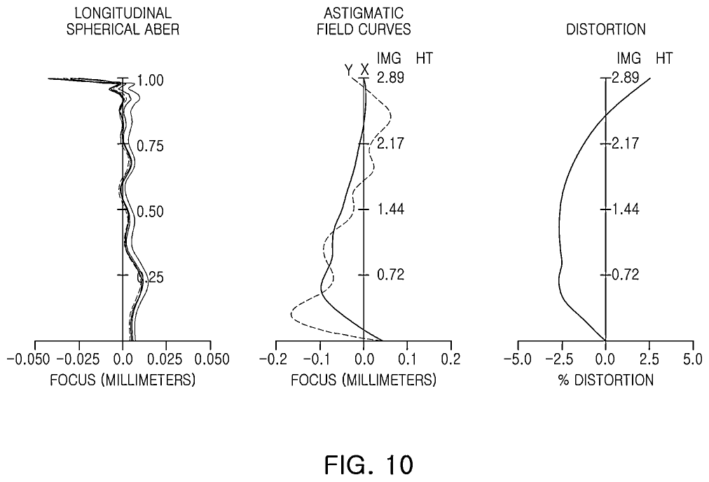

FIG. 9 is a configuration diagram of the second lens module of the second lens assembly, and FIG. 10 is a diagram illustrating aberration characteristics of the second lens module illustrated in FIG. 9.

The second lens module described with reference to FIGS. 9 and 10 may be any one of a plurality of second lens modules of the second lens assembly 20. In addition, the plurality of second lens modules may all have the same configuration.

In this specification, the object-side surface of each lens refers to a surface close to the object side, and the image side surface refers to a surface close to the image side. In addition, the values for the radius of curvature, thickness, distance, and focal length of the lens are all in mm, and the unit of field of view (FOV) is degree.

In addition, in the description of the shape of each lens, a shape in which one surface is convex means that a paraxial region of the corresponding surface is convex, and a shape in which one surface is concave means that the paraxial region of the corresponding surface is concave. Therefore, the fact that one surface of a lens is convex means that it is convex in the paraxial region.

Meanwhile, the paraxial region refers to a very narrow region near and including the optical axis.

The imaging plane may refer to a virtual plane on which a focus is formed by the second lens module. Alternatively, the imaging plane may refer to a surface of the second image sensor receiving light.

In an example embodiment, the second lens module includes five lenses.

For example, referring to FIG. 9, the second lens module includes a first lens 210, a second lens 220, a third lens 230, a fourth lens 240, and a fifth lens 250 arranged along the optical axis from the object side toward the image side. The first lens 210 to the fifth lens 250 are arranged to be spaced apart from each other by a preset distance along the optical axis (a Z-axis).

The first lens 210 to the fifth lens 250 may be lenses arranged in different lens arrays.

The second lens module may further include an infrared cutoff filter 260 (hereinafter referred to as a ‘filter’) to block infrared rays. The filter 260 is disposed between the fifth lens 250 and an imaging plane 270.

In addition, the second lens module may further include an aperture S for controlling the amount of light.

The aperture S may be disposed between the second lens 220 and the third lens 230.

The first lens 210 to the fifth lens 250 may be formed of plastic.

In addition, the first lens 210 to the fifth lens 250 may each be formed of a plastic material having different optical properties (refractive index, Abbe number, etc.) from lenses disposed to be adjacent to each other.

In an example embodiment, a difference in Abbe numbers between the first lens 210 and the second lens 220 may exceed 30. Also, a difference in Abbe numbers between the second lens 220 and the third lens 230 may exceed 10. In addition, a difference in Abbe numbers between the first lens 210 and the third lens 230 may exceed 15.

In an example embodiment, the second lens 220 may be formed of a plastic material having high refractive index and low dispersion values. For example, the refractive index of the second lens 20 may be greater than 1.64, and the Abbe number thereof may be less than 24.

In an example embodiment, the fourth lens 240 may be formed of a plastic material having high refractive index and low dispersion values. For example, the refractive index of the fourth lens 240 may be greater than 1.67, and the Abbe number thereof may be less than 20.

In an example embodiment, the refractive index of the third lens 230 may be greater than 1.55, and the Abbe number thereof may be less than 40.

In an example embodiment, the lens module may meet a condition of 30<|v1−v2|<50, where v1 is the Abbe number of the first lens 210, and v2 is the Abbe number of the second lens 220.

In an example embodiment, the lens module may meet a condition of 10<|v2−v3|<20, where v2 is the Abbe number of the second lens 220, and v3 is the Abbe number of the third lens 230.

In an example embodiment, the lens module may meet a condition of 15<|v1−v3|<25, where v1 is the Abbe number of the first lens 210, and v3 is the Abbe number of the third lens 230.

The plurality of lenses constituting the second lens module may have an aspherical surface. For example, each of the plurality of lenses may have at least one aspherical surface.

The second lens module according to an example embodiment of the present disclosure may form a focus on the imaging plane 270. The imaging plane 270 may refer to a plane on which a focus is formed by the second lens module. As an example, the imaging plane 270 may refer to one surface of the second image sensor that receives light.

The lens characteristics (a radius of curvature, a thickness of the lens or a distance between lenses, a refractive index, the Abbe number, a focal length) of each lens are listed in Table 2.

TABLE 2

| Surface | | Radius of | Thickness | Refractive | Abbe |
|---|---|---|---|---|---|
| No. | Remark | curvature | or distance | index | number |
| S1 | First lens | 1.305 | 0.748 | 1.549 | 55.99 |
| S2 | | −8.997 | 0.036 | | |
| S3 | Second lens | −71.895 | 0.198 | 1.653 | 23.49 |
| S4 | | 1.874 | 0.178 | | |
| S5 | Aperture | Infinity | 0.238 | | |
| S6 | Third lens | 1.68459 | 0.221 | 1.575 | 37.40 |
| S7 | | 1.826 | 0.240 | | |
| S8 | Fourth lens | −12.684 | 0.237 | 1.688 | 19.24 |
| S9 | | −5.508 | 0.803 | | |
| S10 | Fifth lens | 112.823 | 0.198 | 1.540 | 55.74 |
| S11 | | 1.544 | 0.278 | | |
| S12 | Filter | Infinity | 0.110 | 1.519 | 55.15 |
| S13 | | Infinity | 0.778 | | |
| S14 | Imaging plane | Infinity | | | |

In an example embodiment, the total focal length ft of the second lens module is 5 mm (35 mm equivalent focal length is 62.5 mm), Fno_t is 2.7, and IMG HT_Ft is 3.46 mm.

In an example embodiment, the first lens 210 has positive refractive power, and the object-side surface and the image-side surface of the first lens 210 are convex.

The second lens 220 has negative refractive power, and the object-side surface and image-side surface of the second lens 220 are concave.

The third lens 230 has positive refractive power, the object-side surface of the third lens 230 is convex, and the image-side surface of the third lens 230 is concave.

The fourth lens 240 has positive refractive power, the object-side surface of the fourth lens 240 is concave, and the image-side surface of the fourth lens 240 is convex.

The fifth lens 250 has negative refractive power, the object-side surface of the fifth lens 250 is convex, and the image-side surface of the fifth lens 250 is concave.

In addition, at least one inflection point is formed on at least one of the object-side surface and the image-side surface of the fifth lens 250. For example, the object-side surface of the fifth lens 250 may be convex in the paraxial region and concave in portions other than the paraxial region.

The inflection point refers to a point at which the surface of the lens changes from being concave to being convex or from being convex to being concave.

Meanwhile, both the object-side surface and the image-side surface of the first lens 210 to the fifth lens 250 are aspherical surfaces.

In addition, the second lens module configured in this manner may have the aberration characteristics illustrated in FIG. 10.

The imaging device according to one or more example embodiments of the present disclosure as described herein may be miniaturized in size, while capturing high-resolution images and videos.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An imaging device comprising:
a first lens assembly comprising a plurality of first lens modules and a single first image sensor; and
a second lens assembly comprising a plurality of second lens modules and a single second image sensor,
wherein the first lens assembly and the second lens assembly are arranged to be adjacent to each other,
wherein a field of view of each first lens module of the plurality of first lens modules is wider than a field of view of each second lens module of the plurality of second lens modules, and
wherein f35t/f35w≥2 is satisfied, where f35t is a 35 mm equivalent focal length of the second lens module, and f35w is a 35 mm equivalent focal length of the first lens module.

2. The imaging device of claim 1, wherein TTL_w/IMG HT_Fw<0.85 is satisfied, where TTL_w is a distance on an optical axis from an object-side surface of a front lens of the first lens module to an imaging plane of the single first image sensor, and IMG HT_Fw is half of a diagonal length of the imaging plane of the single first image sensor.

3. The imaging device of claim 1, wherein Fno_w>fw/IMG HT_Aw is satisfied, where Fno_w is an F-number of the first lens module, and IMG HT_Aw is half a diagonal length of a region of the imaging plane of the single first image sensor divided to correspond to the plurality of first lens modules.

4. The imaging device of claim 1, wherein TTL_t/IMG HT_Ft<1.45 is satisfied, where TTL_t is a distance on the optical axis from an object-side surface of a front lens of the second lens module to an imaging plane of the single second image sensor, and IMG HT_Ft is half of a diagonal length of the imaging plane of the single second image sensor.

5. The imaging device of claim 1, wherein Fno_t>(ft/IMG HT_At)×0.9 is satisfied, where Fno_t is an F-number of the second lens module, and IMG HT_At is half of a diagonal length of a region of the imaging plane of the single second image sensor divided to correspond to the plurality of second lens modules.

6. The imaging device of claim 1, wherein:
the first lens assembly includes a plurality of wide-angle lens arrays arranged in order from an object side to an image side,
the plurality of wide-angle lens arrays respectively include a plurality of lenses, and
the first lens module includes a plurality of lenses arranged in different lens arrays and sharing a single optical axis.

7. The imaging device of claim 1, wherein:
the second lens assembly includes a plurality of tele-lens arrays arranged in order from an object side to an image side,
the plurality of tele-lens arrays respectively include a plurality of lenses, and
the second lens module includes a plurality of lenses arranged in different lens arrays and sharing a single optical axis.

8. The imaging device of claim 1, wherein:
the first lens module includes a first lens, a second lens, a third lens, a fourth lens, and a fifth lens arranged along an optical axis from an object side toward an image side,
the first lens has positive refractive power, and
the second lens has negative refractive power.

9. The imaging device of claim 8, wherein a difference in Abbe numbers between the first lens and the second lens is greater than 30 and less than 50.

10. The imaging device of claim 9, wherein the second lens has a refractive index greater than 1.67 and an Abbe number less than 21.

11. The imaging device of claim 8, wherein the third lens has positive refractive power, and the fourth lens has negative refractive power.

12. The imaging device of claim 1, wherein:
the second lens module includes a first lens, a second lens, a third lens, a fourth lens, and a fifth lens arranged along an optical axis from an object side toward an image side,
the first lens has positive refractive power, and
the second lens has negative refractive power.

13. The imaging device of claim 12, wherein:
a difference in Abbe numbers between the first lens and the second lens is greater than 30 and less than 50, and
a difference in Abbe numbers between the second lens and the third lens is greater than 10 and less than 20.

14. The imaging device of claim 13, wherein the second lens has a refractive index greater than 1.64 and an Abbe number less than 24.

15. The imaging device of claim 12, wherein the fourth lens has positive refractive power, and the fifth lens has negative refractive power.

16. The imaging device of claim 1, wherein the plurality of first lens modules all have substantially the same configuration as each other.

17. The imaging device of claim 1, wherein the plurality of second lens modules all have substantially the same configuration as each other.

18. An imaging device comprising:
a first lens assembly comprising a plurality of first lens modules having substantially the same configuration as each other and a single first image sensor; and
a second lens assembly disposed adjacent to the first lens assembly, and comprising a plurality of second lens modules having substantially the same configuration as each other and a single second image sensor,
wherein a field of view of each first lens module of the plurality of first lens modules is wider than a field of view of each second lens module of the plurality of second lens modules, and
wherein TTL_w/IMG HT_Fw<0.85 is satisfied, where TTL_w is a distance on an optical axis from an object-side surface of a front lens of the first lens module to an imaging plane of the single first image sensor, and IMG HT_Fw is half of a diagonal length of the imaging plane of the single first image sensor.

19. The imaging device of claim 18, wherein f35t/f35w≥2 is satisfied, where f35t is a 35 mm equivalent focal length of the second lens module, and f35w is a 35 mm equivalent focal length of the first lens module.

20. The imaging device of claim 18, wherein TTL_t/IMG HT_Ft<1.45 is satisfied, where TTL_t is a distance on the optical axis from an object-side surface of a front lens of the second lens module to an imaging plane of the single second image sensor, and IMG HT_Ft is half of a diagonal length of the imaging plane of the single second image sensor.

21. The imaging device of claim 18, wherein Fno_w>fw/IMG HT_Aw is satisfied, where Fno_w is an F-number of the first lens module, and IMG HT_Aw is half a diagonal length of a region of the imaging plane of the single first image sensor divided to correspond to the plurality of first lens modules, and
wherein Fno_t>(ft/IMG HT_At)×0.9 is satisfied, where Fno_t is an F-number of the second lens module, and IMG HT_At is half of a diagonal length of a region of the imaging plane of the single second image sensor divided to correspond to the plurality of second lens modules.

22. The imaging device of claim 18, wherein optical axes of the plurality of first lens modules are substantially parallel to each other, and
wherein optical axes of the plurality of second lens modules are substantially parallel to each other.
